(19) United States
(12) Patent Application Publication
(10) Pub. No.: US 2021/0010532 A1
(43) Pub. Date: Jan. 14, 2021

(54) BEARING DEVICE FOR WHEELS

(71) Applicant: JTEKT CORPORATION, Osaka-shi, Osaka (JP)

(72) Inventors: Koki SHIRAMIZU, Yamatotakada-shi (JP); Tatsuya YOKOTA, Tsu-shi (JP)

(73) Assignee: JTEKT CORPORATION, Osaka-shi, Osaka (JP)

(21) Appl. No.: 16/771,182

(22) PCT Filed: Dec. 6, 2018
(86) PCT No.: PCT/JP2018/044949

§ 371 Date: Jun. 9, 2020

(30) Foreign Application Priority Data
Dec. 25, 2017 (JP) 2017-247293

(51) Int. Cl. F16C 19/18; F16C 33/78

(52) U.S. Cl. CPC F16C 19/184; F16C 2326/02; F16C 33/7823

(57) ABSTRACT

The wheel bearing device includes a hub shaft including a flange portion on one axial side of the hub shaft, an outer ring, a plurality of rolling elements, a cage, and a seal member attached to an end portion of the outer ring on the one axial side. A side surface of the flange portion on another axial side of the hub shaft includes a first side surface having first roughness and a second side surface having second roughness larger than the first roughness. The seal member includes a lip provided facing the second side surface, and a distal end of the lip includes a worn surface that is worn by being in sliding contact with the second side surface.

### TECHNICAL FIELD

An aspect of the present invention relates to a wheel bearing device.

### BACKGROUND ART

In a vehicle which is an automobile or the like, a wheel bearing device (a hub unit) is used to rotatably support a wheel. The wheel bearing device includes: a hub shaft including a flange portion to which a wheel is attached, the flange portion being provided on a vehicle outer side; an outer ring provided on a radially outer side of the hub shaft; a plurality of rolling elements such as balls or the like provided between the hub shaft and the outer ring; and a cage that retains the plurality of rolling elements. In this wheel bearing device, a sealing device is provided inside a bearing including the rolling elements provided between the hub shaft and the outer ring so as to prevent a foreign substance which is muddy water or the like from entering an inside of the bearing from an outside of the bearing (for example, see Patent Document 1).

In the wheel bearing device described in Patent Document 1, a lip of a rubber seal member vulcanized and bonded to a core metal press-fitted to an inner periphery of a vehicle outer side end portion of the outer ring is brought into sliding contact with a side surface of the flange portion on a vehicle inner side, so that the foreign substance is prevented from entering the inside of the bearing.

### RELATED ART DOCUMENT(S)

### Patent Document(s)

Patent Document 1: JP-A-2007-100826

### SUMMARY OF THE INVENTION

### Problem to be Solved by the Invention

As an example of a configuration for improving muddy water resistance, as illustrated in FIG. 5, a labyrinth portion 33 may be provided radially outside of a place where a side surface 30a of a flange portion 30 and a lip 32 of a seal member 31 are in contact with each other. In the example illustrated in FIG. 5, a distal end portion 35 provided by extending the seal member 31 to be vulcanized and bonded to a core metal 34 radially outward is protruded toward a vehicle outer side (one side in an axial direction) to form a protruding portion 36, and the labyrinth portion 33 is formed between a distal end surface 36a of the protruding portion 36 and the side surface 30a of the flange portion 30. An amount of muddy water reaching the lip 32 is reduced by narrowing a gap between the seal member 31 and the side surface 30a of the flange portion 30.

However, when the labyrinth portion 33 as illustrated in FIG. 5 is formed, there are the following problems.

Manufacturing and assembling tolerances for each component of a sealing device including the seal member 31 are present. In order to form the labyrinth portion 33, it is necessary to design the labyrinth portion 33 such that the distal end surface 36a of the protruding portion 36 does not contact the side surface 30a of the flange portion 30 even when the tolerances are the worst, that is, even when a length of the protruding portion 36 protruding toward the vehicle outer side is the largest. Therefore, it is necessary to increase a nominal value of a clearance (the gap between the distal end surface 36a of the protruding portion 36 and the side surface 30a of the flange portion 30). However, when the nominal value is increased, the clearance is increased in turn depending on the tolerances and does not function as a labyrinth, and an entering amount of muddy water cannot be reduced.

When the distal end surface 36a of the protruding portion 36 contacts the side surface 30a of the flange portion 30, abnormal noise may be generated. When the distal end surface 36a of the protruding portion 36 and the side surface 30a of the flange portion 30 are in sliding contact, the protruding portion 36 formed of rubber or the like may break, and the labyrinth portion 33 may be damaged.

An aspect of the present invention has been made in view of the above-described circumstances, and an object thereof is to provide a wheel bearing device capable of forming a stable labyrinth portion and improving muddy water resistance.

### Means for Solving the Problem

One aspect of the present invention provides a wheel bearing device according to the following (1).

(1) A wheel bearing device including: a hub shaft including a flange portion to which a wheel is attached, the flange portion being provided on one axial side of the hub shaft; an outer ring provided on a radially outer side of the hub shaft; a plurality of rolling elements provided between the hub shaft and the outer ring; a cage configured to retain the plurality of rolling elements; and a seal member attached to an end portion of the outer ring on the one axial side, in which a side surface of the flange portion on another axial side of the hub shaft includes a first side surface having first roughness and a second side surface having second roughness larger than the first roughness, and in which the seal member includes a lip provided facing the second side surface, and a distal end of the lip includes a worn surface that is worn by being in sliding contact with the second side surface.

In the wheel bearing device according to the aspect of the present invention, the distal end of the lip of the seal member serves as a worn surface worn by being in sliding contact with the second side surface of the flange portion. The distal end of the lip is brought into sliding contact with the second side surface at a stage before the wheel bearing device is mounted on a vehicle and is used by a user (an inspection stage at the factory or the like) or at an initial stage of using the wheel bearing device by the user, so that this wear occurs. The worn surface of the distal end of the lip and the second side surface of the flange portion are in contact with each other with a contact pressure of zero or a very small contact pressure approximately equal to zero. Accordingly, it is possible to form a very small gap (a labyrinth) between the worn surface of the distal end of the lip and the second side surface of the flange portion, and to improve the muddy water resistance. The worn surface, to which the wear has progressed to an extent, is in slightly contact with or not in contact with the second side surface of the flange portion, and wear does not progress further. Accordingly, it is possible to form a stable labyrinth portion between the distal end of the lip and the side surface (the second side surface) of the flange.

(2) The wheel bearing device according to (1), in which the worn surface may include a plurality of ridge portions along a circumferential direction.

### Advantages of the Invention

According to the aspect of the present invention, it is possible to provide a wheel bearing device capable of improving muddy water resistance.

### BRIEF DESCRIPTION OF DRAWINGS

FIG. 1 is a sectional view of a wheel bearing device according to an embodiment of the present invention.

FIG. 2 is an enlarged sectional view of a periphery of a seal member of the wheel bearing device illustrated in FIG. 1.

FIG. 3 is a sectional view of a distal end portion of a lip of the seal member.

FIG. 4 illustrates a distal end surface of the lip of the seal member in sliding contact with a second side surface of a flange portion.

FIG. 5 is a sectional view of an example of the seal member.

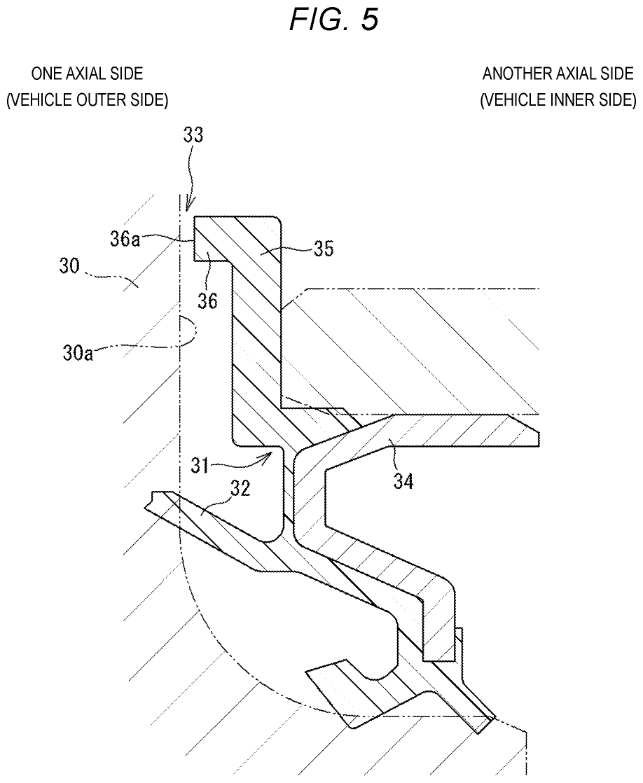

### MODE FOR CARRYING OUT THE INVENTION

Hereinafter, a wheel bearing device according to an embodiment of the present invention will be described in detail with reference to the accompanying drawings. The present invention is not limited to these examples and is defined by the claims, and is intended to include meanings equivalent to the claims and all modifications within the scope of the claims.

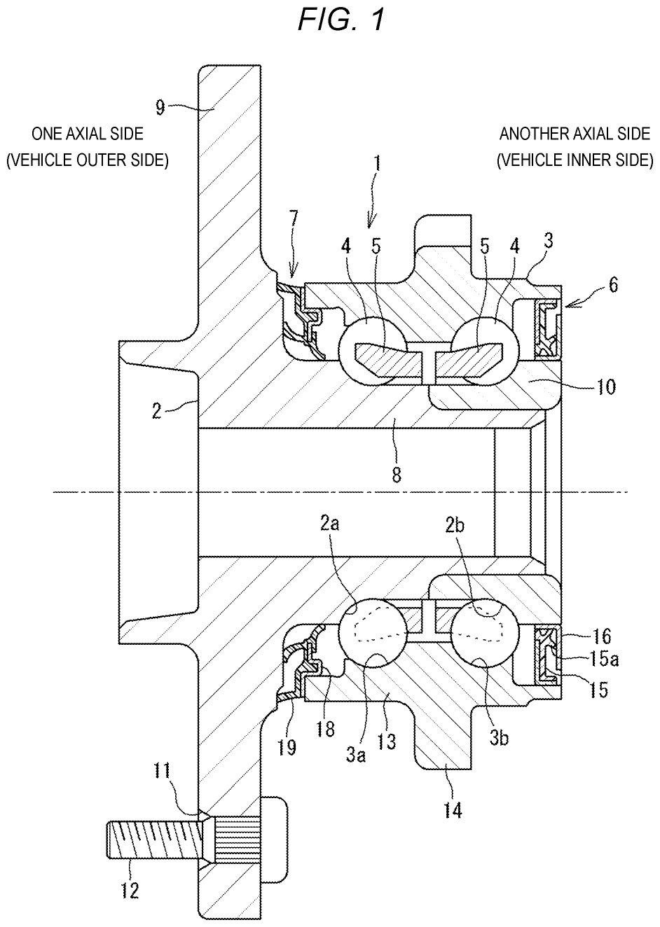

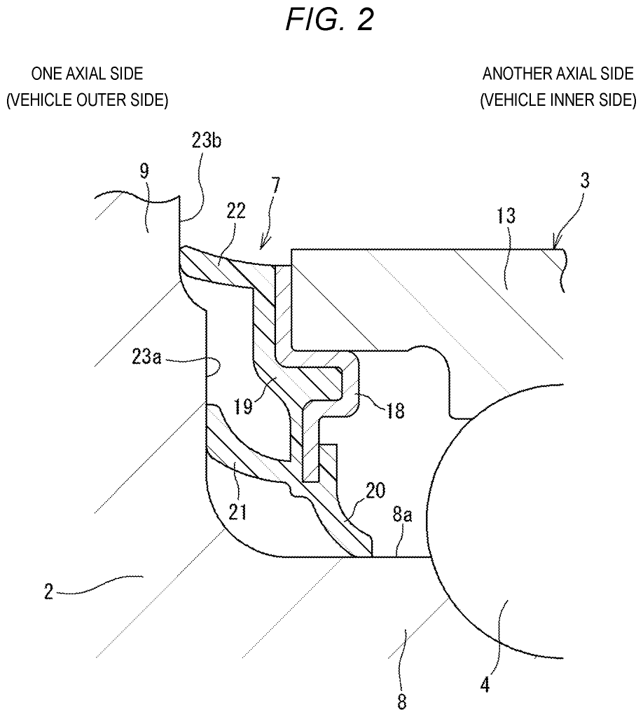

FIG. 1 is a sectional view of a wheel bearing device 1 according to the embodiment of the present invention. FIG. 2 is an enlarged sectional view of a periphery of a seal member of the wheel bearing device 1 illustrated in FIG. 1. The wheel bearing device 1, which is also referred to as a hub unit, is attached to, for example, a suspension device (a knuckle) of a vehicle on a vehicle body side of the vehicle, and is configured to rotatably support a wheel of the vehicle. The wheel bearing device 1 includes a hub shaft 2, an outer ring 3, balls 4 which are rolling elements, a cage 5, and sealing devices 6, 7.

The hub shaft 2 includes an inner shaft and an inner ring member 10. The inner shaft integrally includes a shaft body portion 8 and a flange portion 9 for wheel attachment. The inner shaft is formed of, for example, carbon steel for a mechanical structure. The inner ring member 10 is formed of, for example, high carbon chromium bearing steel. The shaft body portion 8 is a shaft-shaped member that is long in an axial direction. The flange portion 9 is provided to extend radially outward from an end portion of the shaft body portion 8 on a vehicle outer side, and has an annular shape. A plurality of holes 11 are formed in the flange portion 9 along a circumferential direction, and bolts 12 for wheel attachment are attached to the respective holes 11. A wheel and a brake rotor (not illustrated) are attached to the flange portion 9. The inner ring member 10 is an annular member and is fitted and attached to an end portion of the shaft body portion 8 on a vehicle inner side. A shaft raceway surface 2a is formed at an outer peripheral surface of the shaft body portion 8 on the vehicle outer side, and an inner ring raceway surface 2b is formed at an outer peripheral surface of the inner ring member 10.

The outer ring 3 is a cylindrical member, and is formed of, for example, carbon steel for a mechanical structure. The outer ring 3 includes a cylindrical outer ring body 13 and a fixing flange portion 14 extending radially outward from the outer ring body 13. The flange portion 14 is fixed to a knuckle (not illustrated) which is a vehicle body side member, so that the wheel bearing device 1 including the outer ring 3 is fixed to the knuckle.

In a state in which the wheel bearing device 1 is attached on the vehicle body side, a side of the flange portion 9 of the hub shaft 2 is situated on an outer side of the vehicle. In other words, one side in the axial direction on which the flange portion 9 is provided, that is, a left side (a flange portion 9 side) in FIG. 1 corresponds to the vehicle outer side, and another side in the axial direction, that is, a right side in FIG. 1 corresponds to the vehicle inner side.

In the wheel bearing device 1, a direction parallel to a central axis of the wheel bearing device 1, that is, a left-right direction in FIG. 1 is the axial direction of the wheel bearing device 1, and a direction orthogonal to the axial direction is a radial direction.

An outer ring raceway surface 3a on the vehicle outer side and an outer ring raceway surface 3b on the vehicle inner side are formed on an inner peripheral surface of the outer ring 3.

The outer ring raceway surface 3a on the vehicle outer side and the shaft raceway surface 2a face each other in the radial direction, and the outer ring raceway surface 3b on the vehicle inner side and the inner ring raceway surface 2b face each other in the radial direction. The balls 4 are provided between the respective raceway surfaces on the vehicle outer side and between the respective raceway surfaces on the vehicle inner side. The balls 4 are provided in two rows in the axial direction, and the balls 4 in each row are retained by the annular cage 5. The plurality of balls 4 are provided between the hub shaft 2 and the outer ring 3, so that the outer ring 3 is provided concentrically with the hub shaft 2 on a radially outer side of the shaft body portion 8 of the hub shaft 2.

The cage 5 on the vehicle outer side is configured to retain the plurality of balls 4 provided in the row on the vehicle outer side at intervals in the circumferential direction. The cage 5 on the vehicle inner side is configured to retain the plurality of balls 4 provided in the row on the vehicle inner side at intervals in the circumferential direction. The cage 5 can be formed of, for example, a synthetic resin.

The sealing device 6 on the vehicle inner side includes an annular seal member 15 and an annular slinger 16. The seal member 15 is fitted and attached to an inner peripheral surface of a vehicle inner side end portion of the outer ring body 13 of the outer ring 3. The slinger 16 is fitted and attached to an outer peripheral surface of a vehicle inner side end portion of the inner ring member 10 in an interference fit state. A lip 15a of the seal member 15 is in sliding contact with the slinger 16, so that it is possible to prevent a foreign substance which is muddy water or the like from entering an inside of the bearing from an outside on the vehicle inner side. The inside of the bearing is an annular space between the hub shaft 2 and the outer ring 3, and is a region where two rows of balls 4 are provided.

The sealing device 7 on the vehicle outer side is formed of an annular seal member, and the seal member includes a core metal 18 formed of metal and a seal body 19 formed of rubber which is NBR or the like. The sealing device (the seal member) 7 is fitted and attached to an inner peripheral surface of a vehicle outer side end portion of the outer ring body 13 of the outer ring 3.

The seal body 19 is fixed to the core metal 18 by vulcanization bonding. The seal body 19 includes a first lip 20, a second lip 21, and a third lip 22 in order from an inside to an outside in the radial direction. The first lip 20 is in sliding contact with an outer peripheral surface 8a of the shaft body portion 8 of the hub shaft 2, and mainly has a function of preventing grease inside the bearing from flowing out to the outside. The second lip 21 is in sliding contact with the first side surface 23a of the flange portion 9 on the vehicle inner side, and has a function of preventing a foreign substance which is muddy water or the like from entering the inside of the bearing from between the second lip 21 and the first side surface 23a.

The third lip 22, more specifically, a distal end of the third lip 22, is provided facing a second side surface 23b. The second side surface 23b is a side surface of the flange portion 9 on the vehicle inner side, and is situated on the vehicle outer side in the axial direction and the radially outer side with respect to a first side surface 23a with which the second lip 21 is in sliding contact.

The grease is applied to the first lip 20 and the second lip 21. However, no grease is applied to the third lip 22.

The side surface of the flange portion 9 on the vehicle inner side according to the present embodiment includes the first side surface 23a having first roughness and the second side surface 23b having second roughness larger than the first roughness. The first side surface 23a is, for example, a polished surface whose surface is polished, and the second side surface is a turned surface that has been subjected to turning. The second side surface is not limited to the turned surface, and may be a polished surface or a forged surface as long as the second side surface has roughness larger than the roughness of the first side surface.

In the present embodiment, the first side surface 23a, with which the second lip 21 is in sliding contact, is a polished surface whose surface is polished, and the second side surface 23b, to which the distal end of the third lip 22 faces, is a turned surface that is not polished and has been subjected to turning. The roughness of the second side surface (the turned surface) 23b of the flange portion 9 is not particularly limited, and is, for example, Ra2 to Ra30.

The sealing device 7 is manufactured such that the first lip 20, the second lip 21, and the third lip 22 have interferences of, for example, approximately 0 mm or more and 1.5 mm or less, approximately 0.3 mm or more and 2.2 mm or less, and approximately 0 mm or more and 1.2 mm or less, respectively, and are attached to the outer ring 3. Each of the interferences of the second lip 21 and the third lip 22 is a numerical value obtained by subtracting a maximum axial length of the lip in a state in which the wheel bearing device 1 is assembled and the lip is in contact with a side surface of the flange portion 9 of the hub shaft 2 from a maximum axial length of the lip in a state of not being in contact with the side surface of the flange portion 9. On the other hand, the interference of the first lip 20 is a numerical value obtained by subtracting a maximum radial length of the lip in a state in which the wheel bearing device 1 is assembled and the lip is in contact with an outer peripheral surface 8a of the shaft body portion 8 of the hub shaft 2 from a maximum radial length of the lip in a state of not being in contact with the outer peripheral surface 8a of the shaft body portion 8.

Therefore, immediately after the wheel bearing device 1 is assembled, the first lip 20, the second lip 21, and the third lip 22 are respectively pressed against the outer peripheral surface 8a of the shaft body portion 8, the first side surface 23a and the second side surface 23b of the flange portion 9 with a predetermined contact pressure.

Even when the interference of the third lip 22 with respect to the second side surface 23b is 0 (zero), contact occurs between the third lip 22 and the second side surface 23b due to vehicle usage conditions such as a vehicle weight and a load during turning of the vehicle or surface roughness of the third lip 22 and the second side surface 23b, and the distal end of the third lip 22 is worn.

When the vehicle travels in a state in which the wheel bearing device 1 is mounted on the vehicle, and the hub shaft 2 rotates relative to the outer ring 3, the first lip 20, the second lip 21, and the third lip 22 are brought into sliding contact with the outer peripheral surface 8a of the shaft body portion 8, the first side surface 23a of the flange 9, and the second side surface 23b of the flange 9, respectively. In this case, the outer peripheral surface 8a of the shaft body portion 8 and the first side surface 23a of the flange portion 9 are polished surfaces that have been polished, and grease is present on the first lip 20 and the second lip 21, so that the first lip 20 and the second lip 21 can keep sliding contact with almost no wear.

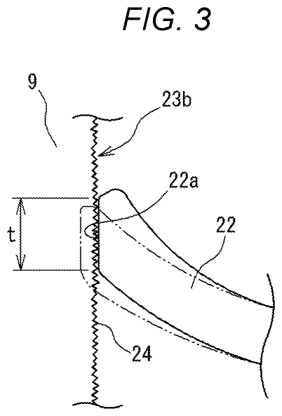

On the other hand, the second side surface 23b of the flange portion 9 with which the third lip 22 is in contact is a turned surface that is not polished and has been turned, and no grease is applied to the second side surface 23b. The turned surface is a surface obtained by turning a forged surface, and as illustrated in FIG. 3, a ridge 24 formed by a turning tool remains spirally in the circumferential direction. A direction of the ridge 24 is not limited to the above, but is preferably a direction having an angle with respect to the circumferential direction. The turned surface is not limited to the surface obtained by turning the forged surface. For example, a surface that has been subjected to primary turning and has been subjected to secondary turning may be referred to as the “turned surface”. In FIG. 3, the ridge 24 is exaggerated for clarity.

The third lip 22 is pressed against the second side surface 23b of the flange portion 9 with a predetermined contact pressure (a first contact pressure) immediately after the wheel bearing device 1 is assembled. When the hub shaft 2 starts to rotate relative to the outer ring 3, the distal end of the third lip 22 wears relatively early (early wear), and the distal end surface 22a of the third lip 22 is in a non-contact state or almost no contact with the facing second side surface 23b. That is, a contact pressure of the third lip 22 against the second side surface 23b of the flange portion 9 is a second contact pressure lower than the first contact pressure. The time required to reach this state varies depending on a speed of relative rotation between the hub shaft 2 and the outer ring 3, a material and the interference of the third lip 22, or the like, but is usually, for example, approximately 24 hours from start of the rotation. After this time has elapsed, initial wear of the distal end of the third lip 22 ends.

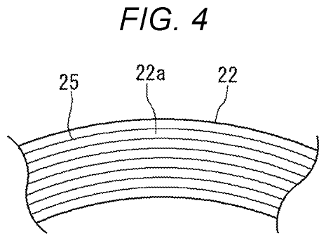

The distal end surface 22a of the third lip 22 after the early wear is a worn surface worn by being in sliding contact with the second side surface 23b which is a turned surface. In the present specification, the “worn surface” refers to a surface having a slid mark (a rubbed mark) caused by the lip 22 and the hub shaft 2 being in contact with each other. This worn surface is a substantially flat surface unlike the second side surface 23b which is a turned surface, but has a plurality of ridge portions 25 along the circumferential direction as illustrated in FIG. 4 when observed in detail. On the other hand, in a part of the second side surface 23b of the flange portion 9 with which the third lip 22 is in sliding contact, the distal end of the ridge 24 is slightly worn due to the sliding contact with the third lip 22. A part of the second side surface 23b of the flange portion 9 with which the third lip 22 is in sliding contact has a color different from that of the other parts since the rubber lip is in sliding contact with the part of the second side surface 23b and a part of the rubber adheres to the part of the second side surface 23b.

The distal end surface 22a of the third lip 22 that has been early worn is in the non-contact state or almost no contact with the facing second side surface 23b, so that the distal end surface 22a of the third lip 22 is not in sliding contact with the second side surface 23b. Therefore, wear does not progress further after the early wear. Accordingly, a labyrinth of a very small gap (a gap between the second side surface 23b and the distal end surface 22a) is formed stably. As a result, it is possible to prevent or reduce a foreign substance which is muddy water or the like from an outside from reaching the second lip 21.

From a viewpoint of promoting wear of the distal end surface 22a of the third lip 22, a pitch of the ridges on the turned surface is preferably narrow, and the ridge is preferably rough (a height of the ridge is high).

If a lip thickness or a contact width t (see FIG. 3) when the distal end surface 22a of the third lip 22 is in sliding contact on the second side surface 23b is increased, abnormal noise may be generated during the initial wear, so that it is desirable to set a size of the third lip 22 to be, for example, approximately 2 mm or less.

In the wheel bearing device according to the present embodiment, the distal end surface of the lip that is at a radially outermost side of the seal member on the vehicle outer side is a worn surface worn by being in sliding contact with the second side surface (the turned surface) of the flange portion. The worn surface of the distal end of the lip and the second side surface of the flange portion are in contact with each other with a contact pressure of zero or a very small contact pressure approximately equal to zero. Accordingly, it is possible to form a very small gap as close to zero as possible between the worn surface of the distal end of the lip and the second side surface of the flange portion, and to improve the muddy water resistance.

### Other Modification

The present invention is not limited to the above-described embodiments, and various modifications can be attained within the scope of the claims.

For example, in the above-described embodiment, the number of the lips that are in sliding contact with the facing surface in the sealing device on the vehicle outer side is two (the first lip and the second lip). However, this number may be one or three or more. A shape of the seal body including the lip and a shape of the core metal can be appropriately changed.

In the above-described embodiment, the ball is used as the rolling element. However, the present invention can also be applied to a wheel bearing device including, for example, a tapered roller other than the ball as the rolling element.

The present application is based on a Japanese Patent Application (No. 2017-247293) filed on Dec. 25, 2017, contents of which are incorporated herein by reference.

### DESCRIPTION OF REFERENCE SIGNS

1: wheel bearing device
2: hub shaft
3: outer ring
4: ball (rolling element)
5: cage
6: sealing device
7: sealing device
8: shaft body portion
9: flange portion
10: inner ring member
11: hole
12: bolt
13: outer ring body
14: flange portion
15: seal member
16: slinger
18: core metal
19: seal body
20: first lip
21: second lip
22: third lip
23a: first side surface
23b: second side surface
24: ridge
25: ridge portion

1. A wheel bearing device comprising:
a hub shaft comprising a flange portion to which a wheel is attached, the flange portion being provided on one axial side of the hub shaft;
an outer ring provided on a radially outer side of the hub shaft;
a plurality of rolling elements provided between the hub shaft and the outer ring;
a cage configured to retain the plurality of rolling elements; and
a seal member attached to an end portion of the outer ring on the one axial side,
wherein a side surface of the flange portion on another axial side of the hub shaft comprises a first side surface having first roughness and a second side surface having second roughness larger than the first roughness, and
wherein the seal member comprises a lip provided facing the second side surface, and a distal end of the lip comprises a worn surface that is worn by being in sliding contact with the second side surface.

2. The wheel bearing device according to claim 1,
wherein the worn surface comprises a plurality of ridge portions along a circumferential direction.
